(19) United States
(12) Patent Application Publication
(10) Pub. No.: US 2004/0196322 A1
(43) Pub. Date: Oct. 7, 2004

(54) Image recording method and image recording apparatus

(75) Inventors: Atsushi Nakajima, Tokyo (JP); Shuta Hamada, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Holdings, Inc., Tokyo (JP)

(21) Appl. No.: 10/802,144

(22) Filed: Mar. 16, 2004

(30) Foreign Application Priority Data
Mar. 28, 2003 (JP) 2003-091110

(51) Int. Cl. B41J 29/38

(52) U.S. Cl. 347/14; 347/102

(57) ABSTRACT

An image recording method having: forming an image by jetting an ultraviolet curable ink on a recording medium from a recording head of an ink jet system; thereafter, curing and fixing the ink placed on the recording medium by irradiation with an ultraviolet-ray; and selecting a jet condition of the recording head for an image formation from a plurality of jet conditions stored for each type of the recording medium, depending on a type of the recording medium to be used.

### BACKGROUND OF THE INVENTION

1. Field of the Invention

The present invention relates to an image recording method and an image recording apparatus and, more particularly, to an image recording method and an image recording apparatus for fixing an image on a recording medium by radiating ultraviolet-rays.

2. Description of the Related Art

As a system for recording an image to an recording medium having no particular image reception layer, UV (ultraviolet) ink jet recording system which uses UV curable ink has been known, in which a recording medium is irradiated with UV-rays after the UV curable ink was jetted thereon to cure and fix the UV curable ink, thereby recording an image on the recording medium (see, for example, JP-Tokukaihei-6-200204A and JP-Tokukai-2000-504778A). Since the UV curable ink is fixed on a recording medium which is not specially treated, an image can be recorded on various types of recording medium. A recording medium containing no chemical compound inhibiting ink curing with UV-rays, such as a printing paper, copy paper, synthetic paper, various types of plastic films, various metals, wood, glass, various cloths or the like, can be employed in the UV ink jet recording system.

UV curable ink is spread on the recording medium from the time the ink is jetted thereon to the time the ink is irradiated with UV-rays, that is, before the ink being cured. The condition of the ink spread depends on properties of each recording medium such as an ink absorptivity, ink affinity or the like, so that a dot diameter and a dot shape differ at the time of UV-ray irradiation depending upon the type of the recording medium. It would cause uneven image quality depending upon the type of the recording medium.

### SUMMARY OF THE INVENTION

An object of the present invention is to-stabilize image quality independently of a type of a recording medium.

In accordance with a first aspect of the present invention, the image recording method of the present invention comprises:

forming an image by jetting an ultraviolet curable ink on a recording medium from a recording head of an ink jet system; thereafter

curing and fixing the ink placed on the recording medium by irradiation with an ultraviolet-ray; and

selecting a jet condition of the recording head for an image formation from a plurality of jet conditions stored for each type of the recording medium, depending on the recording medium to be used.

In accordance with a second aspect of the present invention, the image recording apparatus of the present invention comprises:

a recording head of an ink jet system for forming an image by jetting an ultraviolet curable ink on a recording medium;

a light source for irradiating the recording medium with an ultraviolet ray to cure and fix the ink placed on the recording medium;

an input section for inputting a type of the recording medium;

a storing section for storing a jet condition for each type of the recording medium; and

a control section which identifies the type of the recording medium to be used based on an input result through the input section, and selects a jet condition corresponding to the type identified, for controlling the recording head.

According to the image recording method of the first aspect and the image recording apparatus of the second aspect of the present invention, a jet condition for image formation is selected, depending on the type of the recording medium to be used, from the plurality of jet conditions stored for each type of the recording medium, enabling to jet the ink under a jet condition optimum for the recording medium to be used for image formation, and to obtain stable output density characteristics and gradation even if a variety of types of the recording medium are used. In particular, setting and storing of the jet conditions for each type of the recording medium possibly be used, so as to ensure stable image quality for every recording medium, makes it possible to stabilize the image quality, without allowing the image quality to vary from type to type of the recording medium.

Preferably, in the method of the first aspect of the present invention, the jet condition comprises a tone curve which is set depending on a type of the recording medium for determining an amount of ink to be jetted for individual colors in response to an input signal.

Preferably, in the apparatus of the second aspect the present invention, the storing section stores a plurality of tone curves as the jet condition, each of which is set depending on a type of the recording medium for determining an amount of ink to be jetted for individual colors in response to an input signal.

Accordingly, by preliminarily preparing and storing the tone curves adaptive to each type of the recording medium, an optimum tone curve for the recording medium on which the image to be recorded is selected even when the tone curve is used as the jet condition, and the ink is jetted in response to the selected tone curve. This successfully stabilizes image quality without allowing the image quality to vary from type to type of the recording medium.

Preferably, in the method of the first aspect of the present invention, for a case where the recording medium has a low ink absorptivity, the tone curve having an output coefficient for a highlighted area smaller than that of a case where the recording medium has a high ink absorptivity is used.

In the case of using the recording medium having a low ink absorptivity, the ink placed on the recording medium would be spread thereon without absorbing into the recording medium until being cured by UV irradiation. For such a recording medium, it is difficult to obtain a desirable gradation under low density due to a large degree of dot gain in the highlighted area. Therefore, for the recording medium having a low ink absorptivity, by using a tone curve having an output coefficient for the highlighted area smaller than that used for the case where the recording medium has a high ink absorptivity, a desirable gradation can be obtained even in the low-density area.

Preferably, in the method of the first aspect of the present invention, for a case where the recording medium has a glossiness larger than a predetermined value, the tone curve having an output coefficient for a highlighted area smaller than that of a case where the recording medium has a glossiness smaller than the predetermined value is used.

The ink absorptivity tends to become large when the surface of the recording medium is porous. Specially, a glossiness is decreased on the porous surface. Thus, for the recording medium having a glossiness larger than the predetermined value, a desirable gradation can be obtained even in the low-density area by using a tone curve having a small output coefficient for the highlighted area.

Preferably, in the method of the first aspect of the present invention, for a case where the ultraviolet curable ink comprises a non-water-based ink, the tone curve having an output coefficient for a highlighted area smaller than that of a case where the ultraviolet curable ink comprises a water-based ink is used.

The condition of ink spread on the recording medium depends on a surface tension of the ink. The non-water-based ultraviolet curable ink has a surface tension smaller than that of the water-based ultraviolet curable ink, so that a dot gain in the highlighted area becomes large. That is, for the case where the ultraviolet curable ink is the non-water-based ink, a desirable gradation can be obtained even in the low-density area by using a tone curve having an output coefficient for the highlighted area smaller than that of the case where the ultraviolet curable ink is the water-based ink.

Preferably, in the method of the first aspect of the present invention, for the case where the ultraviolet curable ink comprises s non-water-based ink, the tone curve having an output coefficient for the highlighted area smaller than that of a case where the ultraviolet curable ink comprises s water-based ink is used to the recording medium having a glossiness larger than a predetermined value.

The non-water-based ink used as the ultraviolet curable ink has a surface tension larger than that of the water-based ink, and this makes it difficult to obtain a desirable gradation under low density due to a large degree of dot gain in the highlighted area on the recording medium having a glossiness larger than a predetermined value. In contrast to this, the non-water-based ink used as the ultraviolet curable ink for the recording medium having a glossiness larger than a predetermined value according to the invention described is successful in obtaining a desirable gradation even in the low-density area by using a tone curve having an output coefficient for the highlighted area smaller than that of the case where the water-based ink is used as the ultraviolet curable ink.

Preferably, in the method of the first aspect of the present invention, the jet condition comprises a limit amount of ink for determining a total amount of ink to be jetted per pixel based on a total input signal.

Preferably, in the apparatus of the second aspect of the present invention, the storing section stores a plurality of limit amounts of ink as the jet condition, each of which is set depending on a type of the recording medium for determining a total amount of ink to be jetted in response to a total input signal.

The limit amount of ink adaptive to the types of the recording medium is preliminarily prepared and stored as the jet conditions, so that an optimum limit amount of ink for the recording medium on which the image to be recorded is selectable even when the limit amount of ink for determining the total amount of ink to be jetted per pixel is used as the jet condition, and the ink is jetted depending on the limit amount of ink. This successfully stabilizes image quality without allowing the image quality to vary from type to type of the recording medium.

Preferably, in the method of the first aspect of the present invention, for a case where the ultraviolet curable ink comprises a water-based ink, a limit amount of ink is reduced from that of a case where the ultraviolet curable ink comprises a non-water-based ink to the recording medium having a glossiness smaller than a predetermined value.

The water-based ink used as the ultraviolet curable ink has a permeability larger than that of the non-water-based ink, and may permeate into the recording medium to thereby cause cockling or the like when the recording medium has a glossiness smaller than the predetermined value. In contrast to this, when the recording medium has a glossiness smaller than the predetermined value, the water-based ink as the ultraviolet curable ink is used under a limit amount of ink reduced from that of the case where the ultraviolet curable ink is the non-water-based ink, so that the amount of permeation into the recording medium can successfully be reduced, and the cockling is avoidable.

Preferably, in the method of the first aspect of the present invention, a type of the recording medium is identified using a gloss sensor, and the jet condition is selected depending on the type of the recording medium identified.

Preferably, in the apparatus of the second aspect of the present invention, the input device comprises a gloss sensor for detecting a gloss of the recording medium.

Because the type of the recording medium is identified using the gloss sensor, and the jet condition is selected depending on the type of the recording medium identified, the type of the recording medium can be identified automatically without a need to input a type of the recording medium by a user. In particular, the above-described output density characteristics and gradation correlate with the gloss, so that use of the gloss as a reference results in an efficient identification of the types of the recording medium.

### BRIEF DESCRIPTION OF THE DRAWINGS

The present invention will become more fully understood from the detailed description given hereinafter and the accompanying drawings which are given by way of illustration only, and thus are not intended as a definition of the limits of the present invention, and wherein;

FIG. 1 is a schematic view showing an overall configuration of an image recording apparatus according to the present embodiment;

FIG. 2 is a graph showing characteristics of a gloss sensor provided in the image recording apparatus shown in FIG. 1;

FIG. 3 is a block diagram of a main control device of the image recording apparatus shown in FIG. 1; and

FIG. 4 is a schematic view showing a modified embodiment of the image recording apparatus shown in FIG. 1.

### DETAILED DESCRIPTION OF THE PREFERRED EMBODIMENTS

Hereinafter, the preferred embodiments of the present invention will be described in detail. The description is not intended to limit the scope of the technique of the claims or the meanings of terms. Also, the assertive explanation in the embodiments of the present invention below only exemplifies the best mode, and is not intended to limit the scope of the technique of the claims or the meanings of terms.

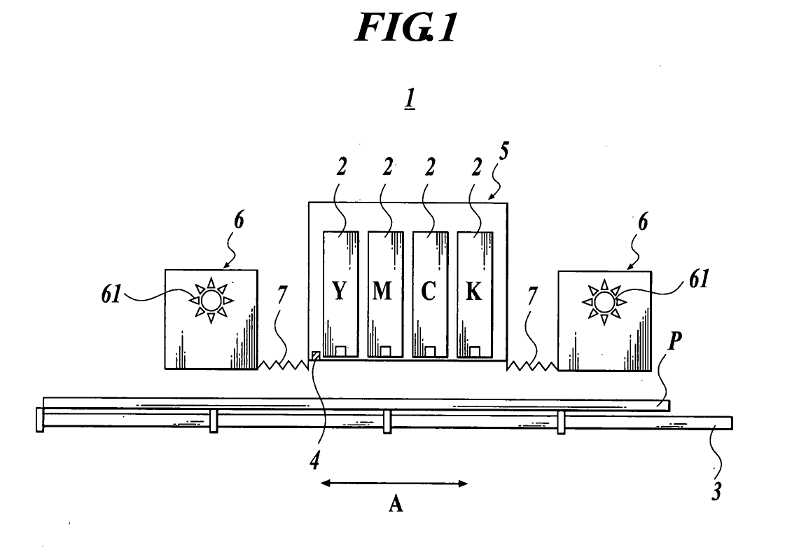

An embodiment of the present invention will be explained referring to FIGS. 1 to 4.

FIG. 1 is a front view showing a main configuration of an image recording apparatus 1, which is a serial type ink jet recording apparatus in which an image is formed using ultraviolet-ray (UV-ray) curable ink while scanning a recording head 2 in a direction perpendicular to a carrying direction of a recording medium P. As shown in FIG. 1, the image recording apparatus 1 comprises a platen 3 for supporting the recording medium P from below. The recording medium P supported by the platen 3 is adapted to be carried by a carrying device which is not shown.

Any one of a nonabsorbent and an absorbent recording medium can be employed as the recording medium P. The term of nonabsorbent indicates that the recording medium P does not absorb any ink compound (hereinafter simply named “ink”), however, in the present invention, when the amount of transferring ink in Bristow method was less than 0.1 ml/mm², a recording medium on which practically 0 ml/mm² of ink was transferred is denoted as the nonabsorbent recording medium. Other recording media are denoted as the absorbent recording medium.

As the nonabsorbent recording medium, for example, various types of nonabsorbent plastics and films thereof used for so-called flexible packaging can be employed in addition to a normal non-coated paper, coated paper or the like. As the various types of nonabsorbent plastics, a PET film, OPS film, OPP film, ONy film, PE film, TAC film or the like can be applied, and in addition, for example, polycarbonate, acrylate resin, ABS resin, polyacetal, PVA, various rubbers or the like is also applied as a plastic. Preferably, the nonabsorbent plastic has a surface energy in the range of 35 mN/m to 60 mN/m, and more preferably in the range of 40 mN/m to 60 mN/m.

As the absorbent recording medium, for example, a plane paper (copy paper), woodfree paper or the like can be applied.

A pair of guide rail (not shown) which extends in a direction (scanning direction A) perpendicular to the carrying direction of the recording medium P is provided above the platen 3. The carriage 5 is supported by the guide rail reciprocably in the scanning direction A.

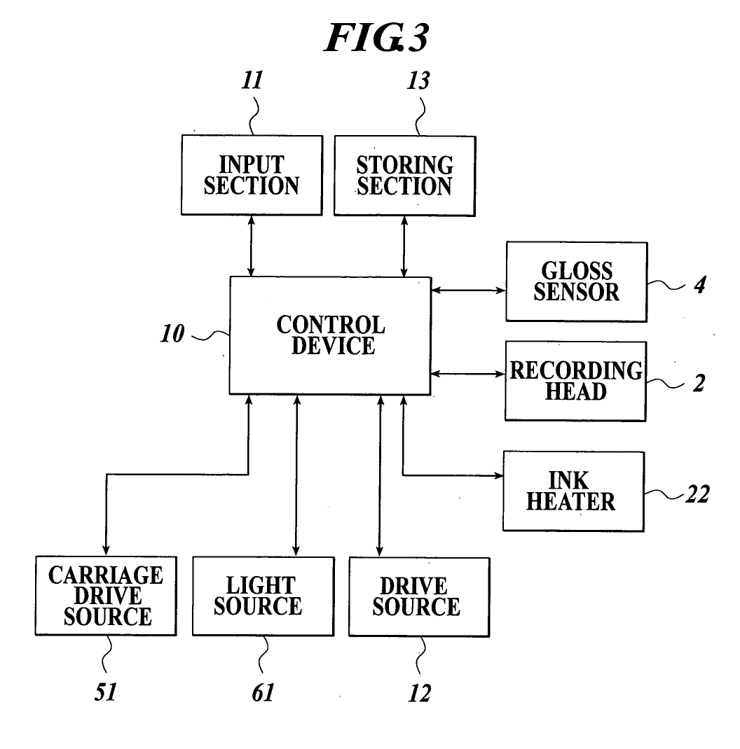

The carriage 5 is provided with a plurality of serial type recording heads 2 for jetting each color of inks (Y: yellow, M: magenta, C: cyan, K: black). The recording heads 2 are mounted to make ink jetting surfaces 21 face the recording medium P supported by the platen 3. Each recording head 2 is provided with an ink heater 22 (refer to FIG. 3) inside thereof, the ink heater 22 heating ink to control temperature. A plurality of nozzles are arranged in line along the carrying direction of the recording medium P in the ink jetting surface 21 of each recording head 2, and the amount of an ink droplet jetted therefrom is set to be 4 to 80 pl. By controlling the amount of the ink droplet to be jetted on a pixel, a total ink film thickness jetted and fixed on the recording medium can be arbitrary adjusted. As a preferred embodiment, by adjusting the maximum ink film thickness per color in the range of 4 to 20 μm, the total ink film thickness can be within the range of 8 to 60 μm, thereby preventing changes of the image quality on the whole recording medium P. The total ink film thickness indicates the maximum value of film thickness of ink jetted on the recording medium P, and is interpreted to have the same meaning in any case of performing recording by the ink jet system with a single color, two color layers (the second color), three color layers or four color layers (white ink base).

An irradiation device 6 is provided through a light shielding member 7 on both sides of the carriage 5 for curing ink jetted on the recording medium P. Each irradiation device 6 is provided with a light source 61 for irradiating the recording medium P with light. That is, in both of back and forth movements of the carriage 5 in the scanning operation, one of the light sources 6 is always positioned on a downstream side of the recording heads 2 in the scanning direction A. Thus, even when the ink is jetted from the recording heads 2 onto the recording medium P during scanning in any one of the back and forth movements, the ink can be irradiated with light immediately after being jetted.

As the light source 6, various types of light sources can be applied to radiate UV-rays, electron beams, X-rays, visible light, infrared light or the like. In view of the curing property, cost or the like, it is preferable to use a light source which radiates UV-rays, such as a fluorescent, a mercury lamp, a metal halide lamp, LED or the like.

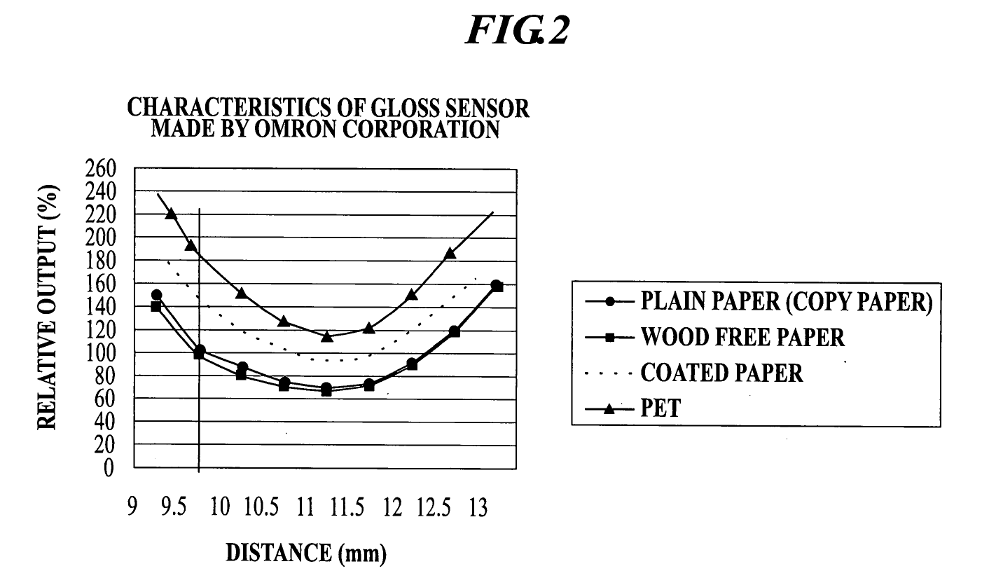

A gloss sensor 4 is disposed between the carriage 5 and the irradiation device 6 for detecting gloss of the recording medium P. The gloss sensor 4 emits light from a light emitting element to the recording medium P to receive reflection light thereof with a light receiving element, thereby detecting a gloss value of the recording medium P to recognize the type of the recording medium P. In the embodiment, for example, a gloss sensor (made by OMRON Corporation) having characteristics as shown in FIG. 2 is employed.

A main control device in the image recording apparatus 1 will be explained referring to FIG. 3.

FIG. 3 is a block diagram showing the main control device in the image recording apparatus 1.

As shown in FIG. 3, the image recording apparatus 1 is provided with a control device 10 for controlling each driving section. The control device 10 is electrically connected to an input section 11 in which instructions for forming an image are input, a drive source 12 of the carrying device, a carriage drive source 51 of the carriage 5, the gloss sensor 4, an ink heater 22, a storage section 13, the recording heads 2 and the light sources 61. Each driving section of the image recording apparatus 1 is also connected to the control device 10.

The control device 10 is adapted to control each section according to a control program or control data written in the storage section 13 based on the instructions from the input section 11.

The storage section 13 stores programs necessary for image forming operations as well as jetting conditions and irradiation conditions for each type of recording medium P which may be used for the image recording apparatus 1.

The jet conditions denote various parameters such as a limit amount of ink, tone curve, temperature or the like of each recording head 2 that are set for each type of recording medium to make a dot diameter and a dot shape of cured ink be constant even when the type of the recording medium P is different.

The tone curve is for determining an output value of an output signal for each color to an input value by adjusting a gradation level of an image with the curve. That is, since the output value is determined by the tone curve, the amount of ink to be jetted for each color can be determined.

Use of the recording medium with a low ink absorptivity causes the dot diameter of the ink placed on the recording medium P to spread without being absorbed into the recording medium P until being cured by UV irradiation. Such a recording medium P has a difficulty in obtaining a desirable gradation under low density due to a large degree of dot gain in the highlighted area. For the recording medium having a low ink absorptivity, a tone curve having an output coefficient for a highlighted area smaller than that of a case where the recording medium has a high ink absorptivity is used, so that a desirable gradation can be obtained even in the low-density area.

The ink absorptivity tends to become large when the surface of the recording medium is porous. Specially, a glossiness is decreased on the porous surface. Thus, for the recording medium having a glossiness larger than the predetermined value, a desirable gradation can be obtained even in the low-density area by using a tone curve having a small output coefficient for the highlighted area.

The ink spread on the recording medium P depends also on a surface tension of the ink. The non-water-based ultraviolet curable ink has a surface tension smaller than that of the water-based ultraviolet curable ink, so that a dot gain in the highlighted area becomes large. That is, for the case where the ultraviolet curable ink is the non-water-based ink, a desirable gradation can be obtained even in the low-density area by using a tone curve having an output coefficient for the highlighted area smaller than that of the case where the ultraviolet curable ink is the water-based ink.

The limit amount of ink denotes a limit value of ink amount to be jetted per pixel from the all recording heads 2 based on the total input signals to all colors. For example, considering a recording medium P such as a nonabsorbent recording medium or the like having a high glossiness and a recording medium P such as an absorbent recording medium or the like having a low glossiness, the limit amount of ink is preferably controlled depending on the type of the recording medium in view of ink dot diameter of the cured ink, internal curing property, suppressing wrinkles and glossiness on the surface of cured ink, and suppressing cockling of the recording medium P.

Specially, for the case where the ultraviolet curable ink is the water-based ink and the recording medium P has a high ink absorptivity, water tends to penetrate into the recording medium P to expand the recording medium P, thereby causing cockling. Therefore, for the case where the ultraviolet curable ink is the water-based ink, the limit amount of ink is reduced from that of a case where the ultraviolet curable ink is the non-water-based ink to the recording medium having a glossiness smaller than a predetermined value and a high ink absorptivity, thereby reducing the amount of ink penetrating into the recording medium. This results in preventing cockling, reducing unreacted monomers remaining in the recording medium P, and suppressing odor.

The temperature of ink when jetted is preferably at least in the range of 35° C. to 100° C. for stably jetting ink. The control range of the ink temperature is set to ±5° C. of the preset temperature, preferably to ±2° C., and more preferably to ±1° C.

The irradiation conditions include an irradiation start time which denotes the time the ink was jetted on the recording medium P to the time UV-rays are radiated.

The irradiation start time denotes from the time the ink was jetted on the recording medium P to the time UV-rays are radiated. The irradiation start time is preferably set to be long for the case of using the nonabsorbent recording medium in comparison with the case of using the absorbent recording medium. To put it concretely, for the nonabsorbent recording medium, the irradiation start time is preferably in the range of 0.001 to 0.6 sec, and for the absorbent recording medium, the irradiation start time is preferably in the range of 0.01 to 2 sec.

In practice, for the jetting conditions and the irradiation conditions, appropriate parameters for each recording medium are obtained by judging outputted test patches. These parameters are stored in the storage section 13. For the irradiation start time, appropriate scanning speed of the carriage 5 for each of the nonabsorbent and absorbent recording materials are set such that UV-rays are radiated within the above described range. The scanning speeds are stored in the storage section 13.

The UV curable ink used in the embodiment will be explained. Preferably, the UV curable ink contains at least a polymerizable monomer, a photo initiator or the like.

Preferable examples of the polymerizable monomer include radical polymerizable monomer and cationic polymerizable monomer. Various (meth)acrylate monomers are available for the radical polymerizable monomer, and examples of which include monofunctional monomers such as isoamyl acrylate, stearyl acrylate, lauryl acrylate, octyl acrylate, decyl acrylate, isomyristyl acrylate, isostearyl acrylate, 2-ethylhexyl-diglycol acrylate, 2-hydroxybutyl acrylate, 2-(acryloyloxy)ethyl hexahydrophthalic acid, butoxyethyl acrylate, ethoxydiethylene glycol acrylate, methoxydiethylene glycol acrylate, methoxypolyethylene glycol acrylate, methoxypropylene glycol acrylate, phenoxyethyl acrylate, tetrahydrofurfuryl acrylate, isobornyl acrylate, 2-hydroxyethyl acrylate, 2-hydroxypropyl acrylate, 2-hydroxyethyl acrylate, 2-hydroxypropyl acrylate, 2-hydroxy-3-phenoxypropyl acrylate, 2-acryloyloxyethyl succinic acid, 2-acryloyloxyethyl phthalic acid, 2-acryloyloxyethyl-2-hydroxyethyl phthalic acid, lactone-modified flexible acrylate, t-butylcyclohexyl acrylate or the like; bifunctional monomers such as triethylene glycol diacrylate, tetraethylene glycol diacrylate, polyethylene glycol diacrylate, tripropylene glycol diacrylate, polypropylene glycol diacrylate, 1,4-butanediol acrylate, 1,6-hexanediol diacrylate, 1,9-nonanediol diacrylate, neopentyl glycol diacrylate, dimethylol tricyclodecane diacrylate, EO adduct diacrylate of bisphenol-A, PO adduct diacrylate of bisphenol-A, hydroxypivalic acid neopentyl glycol diacrylate, polytetramethylene glycol diacrylate, or the like; trifunctional or higher functional monomers such as trimethylolpropane triacrylate, EO-modified trimethylolpropane triacrylate, pentaerythritol triacrylate, dipentaerythritol hexaacrylate, di-trimethylolpropane tetraacrylate, glycerin propoxy triacrylate, caprolactone-modified trimethylolpropane acrylate, pentaerythritolethoxy tetraacrylate, caprolactam-modified di-pentaerythritol hexaacrylate or the like.

As the radical polymerizable monomer, it is preferable to use monofunctional, bi-functional, tri-functional and higher-functional monomers in combination. The monofunctional monomer is highly effective in reducing shrinkage ratio of the cured ink, and its low viscosity is more advantageous in obtaining jetting stability during the ink jet recording. The bi-functional monomer has a proper sensitivity and an excellent adhesiveness to a variety of recording media P. The tri-functional or higher-functional monomer is successful in obtaining a desirable sensitivity and film strength after cured. Combined use of these mono-functional, bi-functional, tri-functional and higher-functional monomers successfully prevents curling and waving due to curing shrinkage, improves the adhesiveness and traceability to the recording medium P, and raises the sensitivity. In particular, it is highly effective when applied to a shrinkable film used in such a way that the recording medium P per se is shrunk after image recording.

It is preferable that the monofunctional monomer is used in an amount of 5 to 40% by mass of the entire portion of the ink composition, the bi-functional monomer in an amount of 5 to 40% by mass, and tri-functional or higher-functional monomer in an amount of 5 to 30% by mass. Preferable combination of the polymerizable monomers is such as ensuring difference between the maximum and minimum values of the solubility parameters (SP values) of 1 or above, and more preferably 1.5 or above, in view of improving adhesiveness to a variety of recording media P, and preventing curling caused by curing shrinkage.

Of these monomers, particularly preferable ones in view of avoiding sensitization property, skin irritativeness, eye irritativeness, mutagenicity and toxicity include isoamyl acrylate, stearyl acrylate, lauryl acrylate, octyl acrylate, decyl acrylate, isomyristyl acrylate, isostearyl acrylate, ethoxydiethylene glycol acrylate, methoxypolyethylene glycol acrylate, methoxypropylene glycol acrylate, isobornyl acrylate, lactone-modified flexible acrylate, tetraethylene glycol diacrylate, polyethylene glycol diacrylate, polypropylene glycol diacrylate, EO-modified trimethylolpropane triacrylate, dipentaerythritol hexaacrylate, ditrimethylolpropane tetraacrylate, glycerinpropoxy triacrylate, caprolactone-modified trimethylolpropane triacrylate, pentaerythritolethoxy tetraacrylate, and caprolactam-modified dipentaerythritol hexaacrylate.

Of these, further preferable ones include stearyl acrylate, lauryl acrylate, isostearyl acrylate, ethoxydiethylene glycol acrylate, isobornyl acrylate, tetraethylene glycol diacrylate, EO-modified trimethylolpropane triacrylate, dipentaerythritol hexaacrylate, di-trimethylolpropane tetraacrylate, glycerinpropoxy triacrylate, caprolactone-modified trimethylolpropane triacrylate, and caprolactam-modified dipentaerythritol hexaacrylate.

Any publicly-known cationic polymerizable monomers can be available. Examples of the monomers include epoxide compounds and vinyl ether compounds disclosed in JP-Tokukaihei-6-9714A, JP-Tokukai-2001-31892A, JP-Tokukai-2001-40068A, JP-Tokukai-2001-55507A, JP-Tokukai-2001-310938A, JP-Tokukai-2001-310937A and JP-Tokukai-2001-220526A.

The epoxide compounds are preferably aromatic epoxide, alicyclic epoxide, aliphatic epixide and so forth. Preferable examples of the aromatic epoxide include di- or poly-glycidyl ether produced by reaction of polyvalent phenol having at least one aromatic nucleus or its alkylene oxide adduct with epichlorohydrin, and examples thereof include bisphenol-A, and di- or poly-glycidyl ether of its alkylene-oxide adduct; hydrogen-added bisphenol-A, and di- or poly-glycidyl ether of its alkylene-oxide adduct; novolac-type epoxy resin or the like. The alkylene oxide can typically be exemplified by ethylene oxide, propylene oxide or the like.

Preferable examples of the alicyclic epoxide are such as those obtained by epoxidating compound having at least one cycloalkane ring such as cyclohexene, cyclopentene or the like, using an appropriate oxidant such as hydrogen peroxide and peracid. Compounds containing cyclohexane oxide or cyclopentene oxide are preferable.

Preferable examples of the aliphatic epoxide include aliphatic polyvalent alcohol, di- or poly-glycidyl ether of its alkylene-oxide adduct and the like, and representatives thereof include diglycidyl ether of alkylene glycol such as diglycidyl ether of ethylene glycol, diglycidyl ether of propylene glycol, and diglycidyl ether of 1,6-hexanediol; polyglycidyl ether of polyhydric alcohol such as di- or tri-glycidyl ether of glycerin or its alkylene-oxide adduct; diglycidyl ether of polyethylene glycol or its alkylene-oxide adduct; and diglycidyl ether of polypropylene glycol or its alkylene-oxide adduct. The alkylene oxide herein can be exemplified by ethylene oxide, propylene oxide and the like.

Of these epoxides, the aromatic epoxide and alicyclic epoxide are preferable in view of their rapid curing properties, and the alicyclic epoxide is particularly preferable. In the present invention, the epoxide may be used in a singular manner, or in a proper combination of two or more species.

Examples of the vinyl ether compound include di- or trivinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, trimethylolpropane trivinyl ether or the like; and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-O-propylene carbonate, dodecyl vinyl ether, diethylene glycol monovinyl ether, and octadecyl vinyl ether.

Of these vinyl ether compounds, di- or trivinyl ether compounds are preferable while taking curing property, adhesiveness and surface hardness into consideration, and in particular, divinyl ether compounds are preferable. In the present invention, the vinyl compounds may be used in a singular manner, or in a proper combination of two or more species.

The UV-curing ink applicable to the present invention preferably contains a cationic polymerizable monomer out of these monomers, which is unlikely to be affected by oxygen polymerization inhibition, and further preferably contain a compound having oxetane ring(s) in view of curing property. A combined system including an oxetane compound in an amount of 60 to 95% by mass, an oxirane-group-containing compound in an amount of 5 to 40% by mass, and a vinyl ether compound in an amount of 0 to 40% by mass is preferable in view of the curing property and jetting stability.

The oxetane compound refers to a compound having oxetane ring(s), and any publicly-known oxetane compounds, such as those disclosed in JP-Tokukai-2001-220526A and JP-Tokukai-2001-310937A for example, are available.

Use of compounds having five or more oxetane rings may, however, raise problems of degrading the handleability due to an excessively large viscosity of the composition, and of insufficient tackiness of the resultant cured product due to a raised glass transition point of the composition. The oxetane compounds used in the present invention are preferably such as those having one to four oxetane rings.

The compounds having a single oxetane ring can be exemplified by those expressed by the general formula (1).

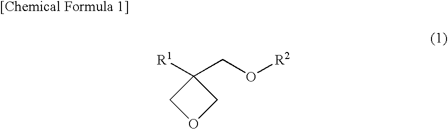

In the formula (1), R1 represents a hydrogen atom; C₁₋₆ alkyl group such as methyl group, ethyl group, propyl group, butyl group or the like; C₁₋₆ fluoroalkyl group; allyl group; aryl group; furyl group or thienyl group. R2 represents a C₁₋₆ alkyl group such as methyl group, ethyl group, propyl group, butyl group or the like; C₂₋₆ alkenyl group such as 1-propenyl group, 2-propenyl group, 2-methyl-1-propenyl group, 2-methyl-2-propenyl group, 1-butenyl group, 2-butenyl group, 3-butenyl group or the like; aromatic-ring-containing group such as phenyl group, benzyl group, fluorobenzyl group, methoxybenzyl group and phenoxybenzylethyl group; C₂₋₆ alkylcarbonyl group such as ethylcarbonyl group, propylcarbonyl group, butylcarbonyl group or the like; C₂₋₆ alkoxycarbonyl group such as ethoxycarbonyl group, propoxycarbonyl group, butoxycarbonyl group or the like; or C₂₋₆ N-alkylcabamoyl group such as ethyl carbamoyl group, propylcarbamoyl group, butylcarbamoyl group, pentylcarbamoyl group or the like. The oxetane compounds used in the present invention are preferably such as those having a single oxetane ring in view of obtaining a desirable tackiness of the resultant composition, and an excellent handleability by virtue of its low viscosity.

The compounds having two oxetane rings can be exemplified by those expressed by the general formula (2).

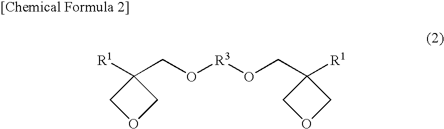

In the formula (2), R1 represents the groups same as those in the formula (1) in the above. R3 typically represents linear or branched alkylene group such as ethylene group, propylene group and butylene group; linear or branched poly(alkyleneoxy) group such as poly(ethyleneoxy) group, poly(propyleneoxy) group or the like; linear or branched unsaturated hydrocarbon group such as propenylene group, methylpropenylene group, butenylene group or the like; carbonyl group; carbonyl-group-containing alkylene group; carboxyl-group-containing alkylene group; or carbamoyl-group-containing alkylene group.

R3 may also be a polyvalent group selected from those expressed by the formulae (3), (4) and (5) below.

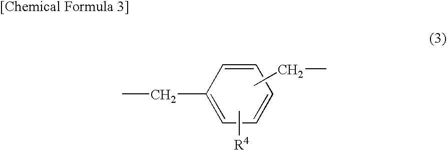

In the formula (3), R4 represents a hydrogen atom; C₁₋₄ alkyl group such as methyl group, ethyl group, propyl group, butyl group or the like; C₁₋₄ alkoxy group such as methoxy group, ethoxy group, propoxy group, butoxy group or the like; halogen atom such as chlorine atom, bromine atom or the like; nitro group; cyano group; mercapto group; lower alkoxycarboxyl group; carboxyl group; or carbamoyl group.

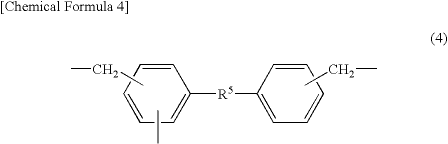

In the formula (4), R5 represents an oxygen atom, sulfur atom, methylene group, NH—, SO—, SO₂—, C(CF₃)₂— or C(CH₃)₂—.

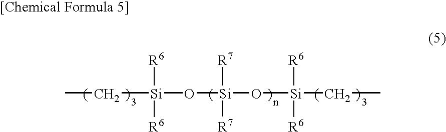

In the formula (5), R6 represents a C₁₋₄ alkyl group such as methyl group, ethyl group, propyl group, butyl group or the like; or aryl group, where n is an integer from 0 to 2,000. R7 represents a C₁₄ alkyl group such as methyl group, ethyl group, propyl group, butyl group or the like; or aryl group.

R7 represents a group selected from those expressed by the formula (6) below.

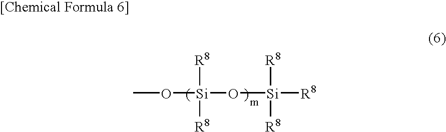

In the formula (6), R8 represents a C₁₋₄ alkyl group such as methyl group, ethyl group, propyl group, butyl group or the like; or aryl group, where m is an integer from 0 to 100.

Specific examples of the compounds having two oxetane rings are such as those expressed by the general formulae (7) and (8) below.

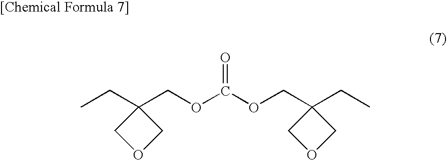

The compounds expressed by the formula (7) are such as those having an ethyl group as R1 and a carboxyl group as R3 in the formula (2).

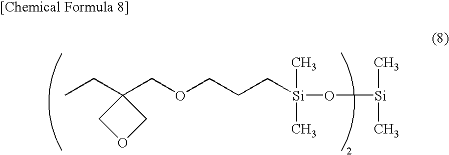

The compounds expressed by the formula (8) are such as those having an ethyl group as R1, and a substituent as R3 in the formula (2), the substituent is expressed by the formula (5), where R6 and R7 represent a methyl group and n is 1.

In the compounds having two oxetane rings, other preferable examples besides those described in the above include those expressed by the general formula (9) below. In the formula (9), R1 represents the groups same as those in the formula (1) in the above.

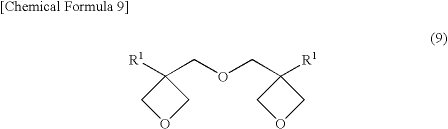

The compounds having three to four oxetane rings can be exemplified by those expressed by the general formula (10) below.

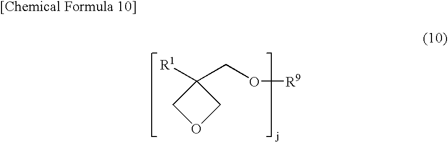

In the formula (10), R1 represents the groups same as those in the general formula (1) in the above. R9 represents a C₁₋₁₂ branched alkylene group such as those expressed by the formulae (11) to (13) below, a branched poly(alkyleneoxy) group expressed by the formula (14) below, a branched polysiloxane expressed by the formula. (15) below, or the like, where j is 3 or 4.

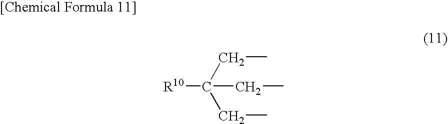

In the formula (11), R10 represents a lower alkyl group such as methyl group, ethyl group, propyl group or the like.

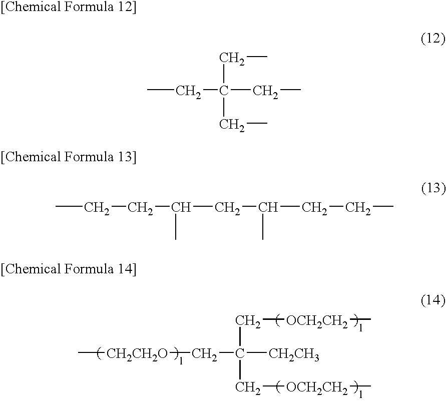

In the formula (14), 1 is an integer from 1 to 10.

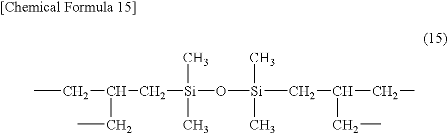

Specific examples of the compounds having three to four oxetane rings are such as those expressed by the general formula (16).

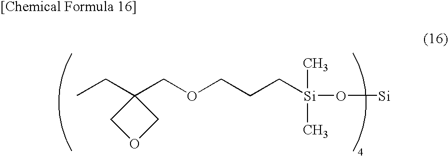

Other preferable examples of the compounds having one to four oxetane rings, besides those described in the above, include those expressed by the general formula (17) below.

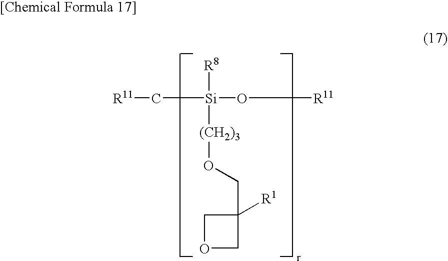

In the formula (17), R1 represents the groups same as those in the formula (1) in the above, and R8 represents the groups same as those in the formula (6). R11 represents a C₁₋₄ alkyl groups such as methyl group, ethyl group, propyl group, butyl group or the like; or a trialkylsilyl group, where r is 1 to 4.

Preferred examples of the oxetane compound available in the present invention will be shown below.

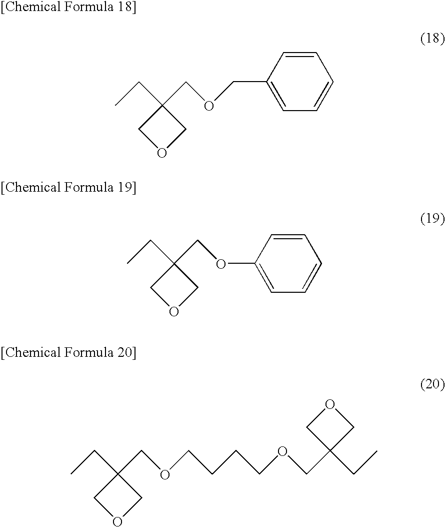

There is no special limitation on a method of producing these compounds having oxetane ring(s), and any known methods can be followed. One proposed production method is a synthetic method of oxetane ring from diol typically disclosed by Pattison (D. B. Pattison, J. Am. Chem. Soc., 3455, 79(1957). Other available compounds include those having a molecular weight of approximately 1,000 to 5,000, and one to four oxetane rings.

The followings can be exemplified as these compounds.

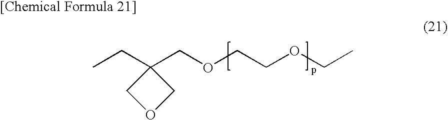

where, p is 20 to 200.

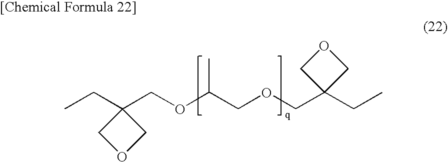

where, q is 15 to 100.

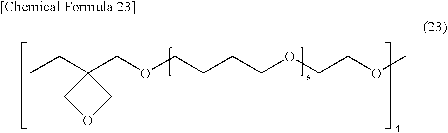

where, s is 20 to 200.

The photo-radical initiator may be any publicly-known initiators such as aryl alkyl ketone, oxime ketone, thiobenzoic acid S-phenyl, titanocene, aromatic ketone, thioxanthone, benzyl and quinone derivatives, ketocoumarins or the like. The initiator is detailed in “UV·EB Koka Gijutsu no Oyo to Shijo (Applications and Market of UV/EB Curing Technology)”, published by CMC Publishing Co., Ltd., supervised by Yoneho Tabata, edited by Radtech Japan). Among others, acylphosphine oxide and acylphosphonate are high in the sensitivity, and can reduce its absorption due to photo-cleavage, so that they are especially effective for internal curing within an ink image of 5 to 12 μm thick per color as in the ink jet system. More specifically, bis (2,4,6-trimethylbenzoyl)-phenylphosphine oxide, bis(2,6-dimethoxybenzoyl)-2,4,4-trimethyl-pentylphosphine oxide or the like is preferable.

As the photo-cationic initiator, those typically used for chemical amplification photoresist or photo-cationic polymerization is available (see “Imejingu-you Yuki Zairyou (Organic Materials for Imaging)”, edited by The Japanese Research Association for Organic Electronics Materials, published by BUN-SHIN (1993), p.187-192; and photo-acid generator described in “Hikari Koka Gijutsu (Photo-Curing Technology)”, edited by Technical Information Institute Co., Ltd. (2001)). Examples of the compounds preferably used for the present invention will be listed below. First examples relate to B(C₆F₅)₄⁻, AsF₆⁻, SbF₆⁻ and CF₃SO₃⁻ salts of aromatic onium compounds such as diazonium, ammonium, iodonium and sulfonium compounds. Those having a borate compound as a counter anion are preferable in view of a large acid generating property. Specific examples of the onium compounds are shown below.

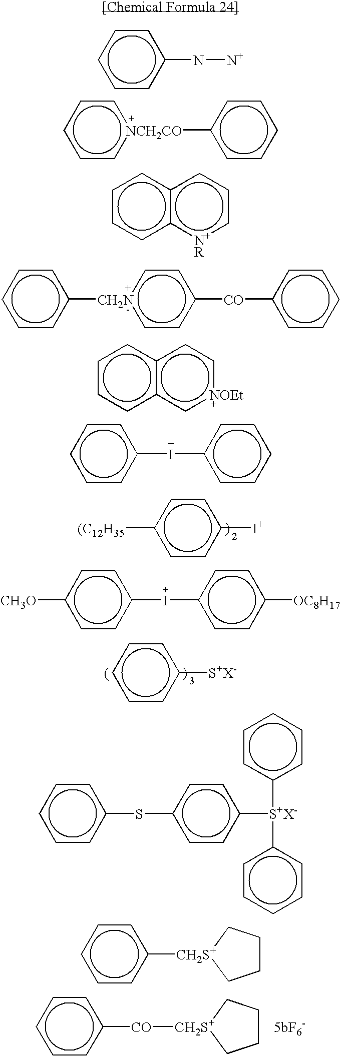

Second examples relate to sulfonated compounds capable of generating sulfonic acid. Specific examples of the compounds will be shown below.

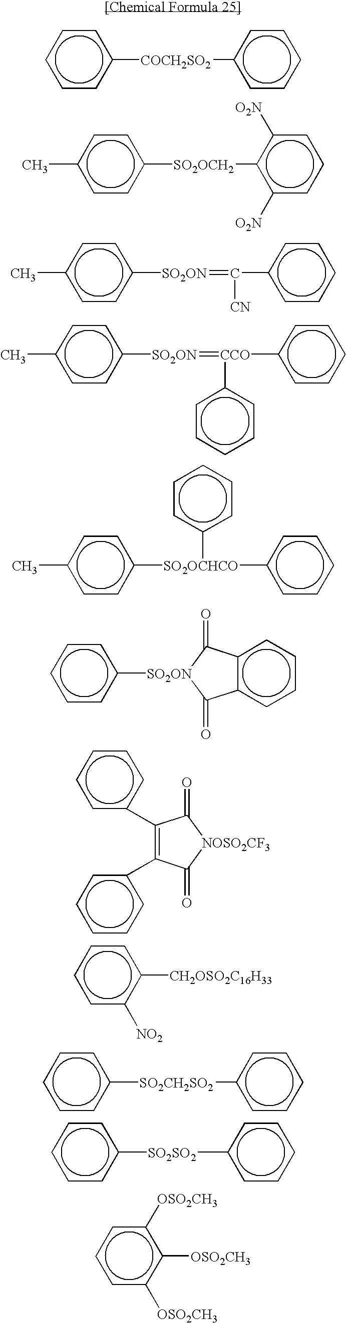

Third examples relate to halogenated compounds capable of generating hydrogen halide. Specific examples of the compounds will be shown below.

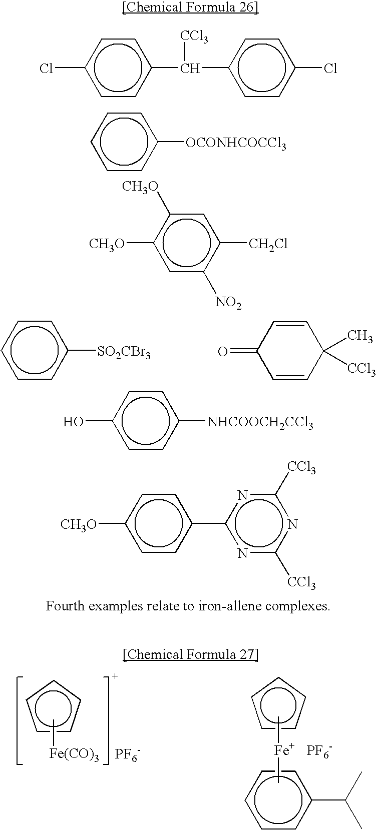

Preferable examples selected in view of safety, similarly to the aforementioned monomers, include 1-hydroxycyclohexyl phenyl ketone, 2-methyl-1-[4-(methylthio)phenyl]-2-morpholinopropane-1-one, bis(2,6-dimethoxybenzoyl)-2,4,4-trimethyl-pentylphosphine oxide, 2-hydroxy-2-methyl-1-phenyl-propane-1-on (Darocure (R) 1173). In a photo-cationic initiator, aromatic onium salt is decomposed to release benzene, so that in view of safety, aromatic onium salt having substituted aryl base is preferably used. The amount of addition is preferably 1 to 6% by mass of the entire ink composition, and is more preferably 2 to 5% by mass. In the present invention, it is preferable to carry out two-step irradiation under different wavelengths and intensities in view of raising the adhesiveness and traceability of the ink film to the recording medium P, and it is also preferable to use two or more initiators which differ in the absorption wavelength in combination.

Polymerizable oligomers can also be blended similarly to the polymerizable monomers. Examples of the polymerizable oligomer include epoxide acrylate, polyester acrylate, straight-chain acryl oligomer or the like.

Beside these additives, it is also allowable to add, if necessary, surfactant; leveling agent; matting agent; and film property adjusting material such as polyester-base resin, polyurethane-base resin, vinyl-base resin, acrylic resin, rubber-base resin, waxes, various types of polymerization inhibitor such as AO agent, amine or the like, lubricant and molding lubricant. Addition of a trace amount of organic solvent is also successful in improving the adhesiveness with the recording medium P. In view of VOC, organic solvent is not preferable by nature, however, the addition in this case is preferably within a range not causative of any problems in solvent resistance and VOC, and the amount is preferably within a range from 0.1 to 5%, and more preferably from 0.1 to 3%.

The ultraviolet curable ink of the present invention preferably has a viscosity at 25° C. of 7 to 50 mPa·s, in view of ensuring stable jetting irrespective of curing environment (temperature, humidity), and ensuring a desirable reproducibility and curing property.

For the case where a transparent material is applied to the recording medium P in the present invention, it is preferable to use white ink in order to raise the hiding power of colors on the recording medium P. Use of the white ink is preferable in particular for printing on flexible packages and labels, but there is of course a limitation on the amount of use thereof in view of the aforementioned jetting stability, and curling or cockling of the recording medium P.

Color materials available for the present invention may any of those soluble or dispersible in main component of the polymerizable compound, where pigment is preferable in view of weatherability. Examples of the pigment preferably be used in the present invention are listed below.

C.I.Pigment Yellow-1, 3, 12, 13, 14, 17, 74, 81, 83, 87, 95, 109, 138, 139, 151, 180;

C.I.Pigment Orange-16, 36, 38;

C.I.Pigment Red-5, 22, 38, 48:1, 48:2, 48:4, 49:1, 53:1, 57:1, 63:1, 144, 146, 185, 101, 122;

C.I.Pigment Violet-19, 23;

C.I.Pigment Blue-15:1, 15:3, 15:4, 18, 60, 27, 29;

C.I.Pigment Green-7, 36;

C.I.Pigment White-6, 18, 21; and

C.I.Pigment Black-7.

Organic solvent or polymerizable compound are applicable as a dispersion medium for dispersing the above-described pigments. The ink applicable to the present invention is jetted from a jet opening, and cures immediately after being placed on the recording medium P, so that too much organic solvent contained as the dispersion medium may result in degradation or odor emission of the recording medium P due to residual portion of the solvent remained in the cured ink. It is therefore preferable for the ink applicable to the present invention to contain no organic solvent or only a suppressed amount of the organic solvent, and instead, to use the polymerizable compound as a major component of the dispersion medium. As the above-described polymerizable compound, it is more preferable to use a monomer having a lowest level of viscosity among any publicly-known monomers, in view of aptitude for the dispersion.

It is also allowable to add a dispersion aid for the dispersion of the pigment in order to enhance efficiency of dispersion of the pigment into the dispersion medium. Polymer dispersion aids are preferably used as the dispersion aid, where those of Solsperse Series manufactured by AVECIA Ltd., for example, are applicable. It is also allowable to use, as a dispersion auxiliary, a synergist corresponded to the individual pigments. These dispersion aid and dispersion auxiliary are preferably used in an amount of 1 to 50 parts by mass relative to 100 parts by mass of the pigment.

Dispersion of the pigment is preferably carried out so as to adjust the mean particle size of the pigment particles within a range from 0.08 to 0.5 μm. The mean particle size of the pigment particles exceeding 0.5 μm raises a problem of lowering of ink transmissivity, and degradation of image quality formed on the recording medium P. On the other hand, the mean particle size lower than 0.08 μm raises a problem of increasing costs for blending of the ink.

Maximum particle size of the pigment particles is preferably adjusted to a range from 0.3 to 10 μm, and more preferably from 0.3 to 3 μm. The maximum particle size of the pigment particles exceeding 10 μm raises a problem that the ink tends to clog within the jet opening. On the other hand, the maximum particle size less than 0.3 μm raises a problem of increase in the cost for blending of the ink.

Selection of the pigment, dispersion aid and dispersion medium, and setting of conditions for the dispersion and filtration, which are required for blending of the ink, are appropriately carried out so as to adjust the mean particle size and maximum particle size to the above-described ranges. This particle size control is successful in suppressing clogging of the head nozzles, and in keeping desirable levels of storage stability of the ink, transparency of the ink, and curing sensitivity.

The ink of the present invention preferably has a color material concentration of 1 to 10% by mass relative to the entire part of the ink. The color material concentration less than 1% by mass raises a problem that the ink does not effectively develop its color on the recording medium P, and the formed image becomes unclear. On the other hand, the color material concentration exceeding 10% by mass raises a problem that the ink cannot rapidly be cured on the recording medium P, and the strength and quality of the image are degraded.

Next, operations of an image recording apparatus 1 during the image formation will be described.

First, a user enters conditions for the image formation through an input section 11 to thereby command start of the image formation. Based on the input, a control device 10 controls a drive source 12 of a carrying device to thereby carry the recording medium P to a predetermined position. Once the recording medium P is carried to the predetermined position, the control device 10 then actuates a gloss sensor 4 to thereby identify a type of the recording medium P to be used. The control device 10 then selects a jet condition and an irradiation condition from a plurality of jet conditions and irradiation conditions preliminarily stored in a storing section 13, corresponding to the identified result. Based on the read-out jet condition and irradiation condition, the control device 10 controls a carriage drive source 51, a drive source 12, a recording head 2 and an ink heater 22, to allow the ink adjusted to an optimum temperature to be jetted from the recording head 2 while carrying the recording medium P at an optimum carrying speed, and to irradiate the placed ink with ultraviolet radiation to thereby allow the ink to be cured and fixed for image formation.

As is described in the above, according to the image recording apparatus 1 of the present embodiment, a jet condition for the image formation is selected from a plurality of jet conditions stored by types of the recording medium P corresponding to the recording medium P to be used, and this makes it possible to jet the ink under an optimum jet condition suited to the type of the recording medium P to be used, and to obtain a stable output density characteristic and gradation even if a variety of types of the recording media P differing in the surface characteristics are used. In particular, it is made possible to stabilize the image quality without causing variation in the image quality by types of the recording medium, if the jet conditions by types of the recording medium possibly be used are set and stored so as to ensure a stable image quality for every type of the recording medium P.

It is to be understood that the present invention is by no means limited to the above-described embodiment, and instead any modifications will be allowable.

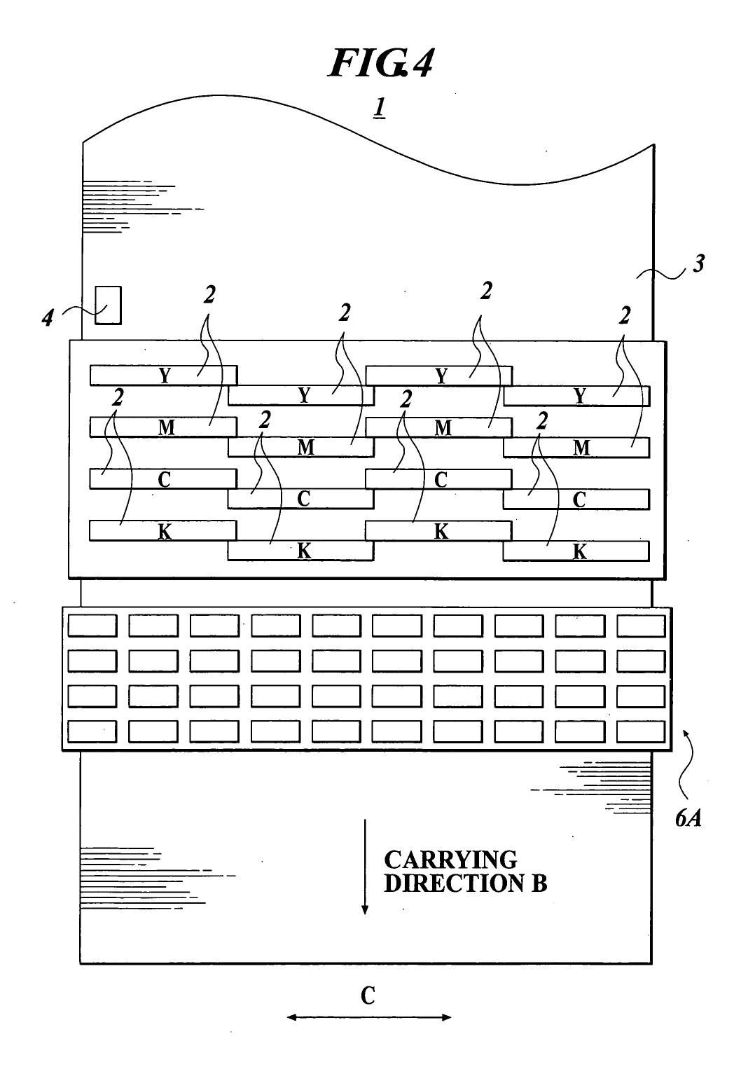

For example, the image recording apparatus 1 of the present embodiment configured as of a serial image recording system may typically be modified into an image recording apparatus 1A based on a line system as shown in FIG. 4, in which line-type recording heads 2A for the individual colors are aligned so as to extend along the transverse direction C as a whole, and so as to be aligned at regular intervals along the carrying direction B. In the image recording apparatus 1A based on the line system, the gloss sensor 4 is disposed on the upstream side of the recording heads 2A on the carrying direction B, and an irradiation device 6A is disposed on the downstream side thereof.

In the present embodiment, the gloss sensor 4 functions as an input device for inputting the types of the recording medium P, so that the image recording apparatus 1 automatically identifies the types of the recording medium P. It is, however, also allowable to configure the image recording apparatus 1 in which a type of the recording medium P is manually entered through an input section by a user before the image formation if the user preliminarily recognizes the type of the recording medium P.

### EXAMPLE

In the present Example, three ink sets, which are a solvent-free cationic polymerizable ink (ink set 1), a solvent-free radical polymerizable ink (ink set 2) and a water-based, a photo-curable ink (ink set 3), are used as ink sets of the ultraviolet curable inks for the individual YMCK colors; and wood free paper, coated paper and PET film are used as the recording media P.

Ink set 1 comprises the inks of the individual colors respectively having compositions shown in Table 1. The dispersant herein is Ajisper PB-822 manufactured by Ajinomoto-Fine-Techno Co., Inc., monomer 1 is Aron Oxetane OXT-221 manufactured by Toagosei Co., Ltd., monomer 2 is Celloxide 2021P manufactured by Daicel Chemical Industries, Ltd., and initiator 1 is a product of Dow Chemical Company.

TABLE 1

| | | | | Y |
|---|---|---|---|---|
| | K | C | M | CI |
| | CI | CI | CI | PIGMENT |
| | PIGMENT | PIGMENT | PIGMENT | YELLOW |
| PIGMENT | BLACK 7 | BLUE 15:4 | RED 146 | 180 |
| PIGMENT | 4 | 4 | 5 | 5 |
| DISPERSANT | 0.12 | 0.12 | 0.15 | 0.15 |
| MONOMER 1 | 70 | 70 | 70 | 70 |
| MONOMER 2 | 30 | 30 | 30 | 30 |
| INITIATOR 1 | 5 | 8 | 5 | 5 |

Ink set 2 comprises the inks of the individual colors respectively having compositions shown in Table 2. Monomer 3 herein is lauryl acrylate (monofunctional), monomer 4 is tetraethylene glycol diacrylate (bifunctional), monomer 5 is caprolactam-modified di-pentaerythritol hexaacrylate (hexafunctional), initiator 2 is Irgacure 2959 manufactured by Ciba Specialty Chemicals, Inc., and initiator 3 is Irgacure 500 manufactured by Ciba Specialty Chemicals, Inc.

TABLE 2

| | | | | Y |
|---|---|---|---|---|
| | K | C | M | CI |
| | CI | CI | CI | PIGMENT |
| | PIGMENT | PIGMENT | PIGMENT | YELLOW |
| PIGMENT | BLACK 7 | BLUE 15:3 | RED 57:1 | 13 |
| PIGMENT | 4 | 4 | 5 | 5 |
| MONOMER 3 | 25 | 20 | 25 | 20 |
| MONOMER 4 | 46.5 | 56 | 50 | 55 |
| MONOMER 5 | 15 | 12 | 12 | 12 |
| INITIATOR 2 | 3 | 3 | 3 | 3 |
| INITIATOR 3 | 3.5 | 2 | 2 | 2 |

Ink set 3 comprises inks of the individual colors respectively having compositions shown in Table 3. Monomer 6 used herein is a monomer expressed by the formula (17), and initiator 4 is an initiator expressed by the formula (18).

TABLE 3

| | | | | Y |
|---|---|---|---|---|
| | K | C | M | CI |
| | CI | CI | CI | PIGMENT |
| | PIGMENT | PIGMENT | PIGMENT | YELLOW |
| PIGMENT | BLACK 7 | BLUE 15:3 | RED 57:1 | 13 |
| PIGMENT | 26 | 25 | 21 | 25 |
| MONOMER 6 | 35 | 35 | 35 | 35 |
| INITIATOR 4 | 2 | 2 | 2 | 2 |
| WATER | 37 | 38 | 42 | 38 |

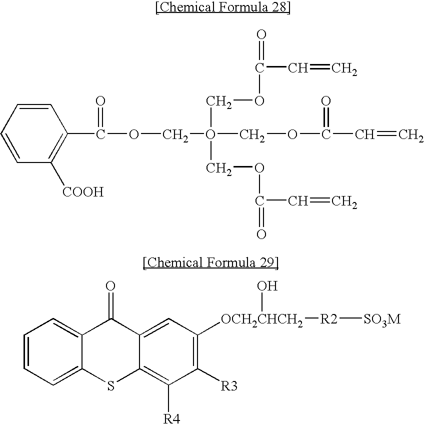

As the jet conditions, tone curves are set so as to be optimized to the individual combinations of ink sets 1 to 3 with each of wood free paper, coated paper and PET film. Tone curve A1 is a smooth tone curve nearly idealized for a combination of wood free paper and ink set 1; tone curve B1 is a smooth tone curve nearly idealized for a combination of coated paper and ink set 1; and tone curve C1 is a smooth tone curve nearly idealized for a combination of PET film and ink set 1. Tone curve A2 is a smooth tone curve nearly idealized for a combination of wood free paper and ink set 2; tone curve B2 is a smooth tone curve nearly idealized for a combination of coated paper and ink set 2; and tone curve C2 is a smooth tone curve nearly idealized for a combination of PET film and ink set 2. Tone curve A3 is a smooth tone curve nearly idealized for a combination of wood free paper and ink set 3; tone curve B3 is a smooth tone curve nearly idealized for a combination of coated paper and ink set 3; and tone curve C3 is a smooth tone curve nearly idealized for a combination of PET film and ink set 3.

The limit amount of ink refers to a value obtained by summing amounts of inks to be jetted of all colors, while assuming that the amounts of inks to be jetted of the individual colors range from 0 to 100%, where 0% is an L* value for the area of the recording medium P having no ink placed therein, and 100% is an L* value for the area having maximum amounts of inks to be jetted of the individual colors. The limit amount of ink is available in three steps of 250%, 300% and 400%.

In Example 1, image was recorded using ink set 1, while applying tone curve A1 and a limit amount of ink of 400% for the wood free paper; tone curve B1 and a limit amount of ink of 400% for the coated paper; and tone curve C1 and a limit amount of ink of 400% for the PET film.

In Example 2, image was recorded using ink set 1, while applying tone curve Al and a limit amount of ink of 250% for the wood free paper; tone curve B1 and a limit amount of ink of 300% for the coated paper; and tone curve C1 and a limit amount of ink of 400% for the PET film.

In Example 3, image was recorded using ink set 2, while applying tone curve C2 and a limit amount of ink of 250% for the wood free paper; tone curve C2 and a limit amount of ink of 300% for the coated paper; and tone curve C2 and a limit amount of ink of 400% for the PET film.

In Example 4, image was recorded using ink set 2, while applying tone curve A2 and a limit amount of ink of 250% for the wood free paper; tone curve B2 and a limit amount of ink of 300% for the coated paper; and tone curve C2 and a limit amount of ink of 400% for the PET film.

In Example 5, image was recorded using ink set 3, while applying tone curve A3 and a limit amount of ink of 250% for the wood free paper; tone curve A3 and a limit amount of ink of 300% for the coated paper; and tone curve A3 and a limit amount of ink of 400% for the PET film.

In Example 6, image was recorded using ink set 3, while applying tone curve A3 and a limit amount of ink of 250% for the wood free paper; tone curve B3 and a limit amount of ink of 300% for the coated paper; and tone curve C3 and a limit amount of ink of 400% for the PET film.

In Comparative Example 1, image was recorded using ink set 1, while applying tone curve A1 and a limit amount of ink of 400% for the wood free paper; tone curve A1 and a limit amount of ink of 400% for the coated paper; and tone curve A1 and a limit amount of ink of 400% for the PET film.

In Comparative Example 2, image was recorded using ink set 1, while applying tone curve C2 and a limit amount of ink of 400% for the wood free paper; tone curve C2 and a limit amount of ink of 400% for the coated paper; and tone curve C2 and a limit amount of ink of 400% for the PET film.

In Comparative Example 3, image was recorded using ink set 3, while applying tone curve A3 and a limit amount of ink of 400% for the wood free paper; tone curve A3 and a limit amount of ink of 400% for the coated paper; and tone curve A3 and a limit amount of ink of 400% for the PET film.

In short, Comparative Examples 1 to 3 record the image using the same tone curves and same limit amount of ink irrespective of the types of the recording medium P, whereas Examples 1 to 6 record the image using the tone curves and limit amount of inks, at least either of which is differed by types of the recording medium P.

Image recording in Examples 1 to 6, and in Comparative Examples 1 to 3 were evaluated by items below.

<Highlight Gradation>

A: smooth gradation in the highlighted area;

B: discrete gradation in the highlighted area, and a slight noise sensible, or ruined gradation with a slightly sensible noise due to blurring of the ink, and degraded sharpness; and

C: enlarged dot diameter and resultant noise in the highlighted area, or increased noise due to blurring of the ink and degraded sharpness.

<Ink Penetration>

A: no ink penetration even in the pixels having the largest amount of ink jetted;

B: slight ink penetration in the pixels having the largest amount of ink jetted; and

C: ink penetration in the pixels having the largest amount of ink jetted.

<Density in 4C Area>

A: stable density in the pixels (4C area) having the largest amount of ink jetted;

B: slightly disturbed density in the pixels having the largest amount of ink jetted; and

C: unstable density in the pixels having the largest amount of ink jetted.

<Cockling>

A: no cockling even in the pixels having the largest amount of ink jetted;

B: slight cockling in the pixels having the largest amount of ink jetted; and

C: cockling observed in the pixels having the largest amount of ink jetted.

<Odor or Image>

A: no odor;

B: slight odor sensible; and

C: strong odor.

Results of the evaluation were listed in Table 4.

TABLE 4

| | | | | LIMIT | | | | | |
|---|---|---|---|---|---|---|---|---|---|
| | INK | | TONE | AMOUNT | HIGHLIGHT | INK | DENSITY IN | | ODOROF |
| | SET | RECORDING MEDIUM | CURVE | OF INK | GRADATION | PENTRATION | 4C AREA | COCKLING | IMAGE |
| EXAMPLE 1 | 1 | WOODFREEPAPER | A1 | 400% | A | B | A | A | A |
| | 1 | COATEDPAPER | B1 | 400% | A | A | A | A | A |
| | 1 | PETFILM | C1 | 400% | A | A | A | A | A |
| COMPARATIVE | 1 | WOODFREEPAPER | A1 | 400% | A | B | A | A | A |
| EXAMPLE 1 | 1 | COATEDPAPER | A1 | 400% | B | A | A | A | A |
| | 1 | PETFILM | A1 | 400% | C | A | A | A | A |
| EXAMPLE 2 | 1 | WOODFREEPAPER | A1 | 250% | A | A | A | A | A |
| | 1 | COATEDPAPER | B1 | 300% | A | A | A | A | A |
| | 1 | PETFILM | C1 | 400% | A | A | A | A | A |
| EXAMPLE 3 | 2 | WOODFREEPAPER | C2 | 250% | B | B | A | A | B |
| | 2 | COATEDPAPER | C2 | 300% | B | A | A | A | A |
| | 2 | PETFILM | C2 | 400% | A | A | A | A | A |
| COMPARATIVE | 2 | WOODFREEPAPER | C2 | 400% | B | C | A | A | C |
| EXAMPLE 2 | 2 | COATEDPAPER | C2 | 400% | B | B | A | A | B |
| | 2 | PETFILM | C2 | 400% | A | A | A | A | A |
| EXAMPLE 4 | 2 | WOODFREEPAPER | A2 | 250% | A | A | A | A | B |
| | 2 | COATEDPAPER | B2 | 300% | A | A | A | A | A |
| | 2 | PETFILM | C2 | 400% | A | A | A | A | A |
| EXAMPLE 5 | 3 | WOODFREEPAPER | A3 | 250% | A | B | A | B | B |
| | 3 | COATEDPAPER | A3 | 300% | B | A | A | B | A |
| | 3 | PETFILM | A3 | 400% | B | A | A | A | A |
| COMPARATIVE | 3 | WOODFREEPAPER | A3 | 400% | A | B | A | C | C |
| EXAMPLE 3 | 3 | COATEDPAPER | A3 | 400% | B | A | A | B | B |
| | 3 | PETFILM | A3 | 400% | C | A | A | A | A |
| EXAMPLE 6 | 3 | WOODFREEPAPER | A3 | 250% | A | B | A | B | B |
| | 3 | COATEDPAPER | B3 | 300% | A | A | A | B | A |
| | 3 | PETFILM | C3 | 400% | A | A | A | A | A |

As shown in Table 4, any of Comparative Examples 1 to 3 has any item(s) evaluated as “C”, whereas-Examples 1 to 6 are completely free from evaluation results of “C”. Example 2, which used ink set 1, and applied different tone curves and limitations of ink amount depending on the types of the recording medium P, showed all items evaluated as “A”.

The entire disclosure of Japanese Patent Applications No. Tokugan 2003-091110 which was filed on Mar. 28, 2003, including specification, claims, drawings and summary are incorporated herein by reference in its entirety.

What is claimed is:

1. An image recording method comprising:
forming an image by jetting an ultraviolet curable ink on a recording medium from a recording head of an ink jet system; thereafter
curing and fixing the ink placed on the recording medium by irradiation with an ultraviolet-ray; and
selecting a jet condition of the recording head for an image formation from a plurality of jet conditions stored for each type of the recording medium, depending on a type of the recording medium to be used.

2. The method of claim 1, wherein the jet condition comprises a tone curve which is set depending on a type of the recording medium for determining an amount of ink to be jetted for individual colors in response to an input signal.

3. The method of claim 2, wherein for a case where the recording medium has a low ink absorptivity, the tone curve having an output coefficient for a highlighted area smaller than that of a case where the recording medium has a high ink absorptivity is used.

4. The method of claim 2, wherein for a case where the recording medium has a glossiness larger than a predetermined value, the tone curve having an output coefficient for a highlighted area smaller than that of a case where the recording medium has a glossiness smaller than the predetermined value is used.

5. The method of claim 2, wherein for a case where the ultraviolet curable ink comprises a non-water-based ink, the tone curve having an output coefficient for a highlighted area smaller than that of a case where the ultraviolet curable ink comprises a water-based ink is used.

6. The method of claim 2, wherein for the case where the ultraviolet curable ink comprises a non-water-based ink, the tone curve having an output coefficient for a highlighted area smaller than that of a case where the ultraviolet curable ink comprises a water-based ink is used to the recording medium having a glossiness larger than a predetermined value.

7. The method of claim 1, wherein the jet condition comprises a limit amount of ink for determining a total amount of ink to be jetted per pixel based on a total input signal.

8. The method of claim 4, for a case where the ultraviolet curable ink comprises a water-based ink, a limit amount of ink is reduced from that of a case where the ultraviolet curable ink comprises a non-water-based ink to the recording medium having a glossiness smaller than a predetermined value.

9. The method of claim 1, a type of the recording medium is identified using a gloss sensor, and the jet condition is selected depending on the type of the recording medium identified.

10. An image recording apparatus comprising:
a recording head of an ink jet system for forming an image by jetting an ultraviolet curable ink on a recording medium;
a light source for irradiating the recording medium with an ultraviolet ray to cure and fix the ink placed on the recording medium;
an input section for inputting a type of the recording medium;
a storing section for storing a jet condition for each type of the recording medium; and
a control section which identifies the type of the recording medium to be used based on an input result through the input section, and selects a jet condition corresponding to the type identified, for controlling the recording head.

11. The apparatus of claim 10, the storing section stores a plurality of tone curves as the jet condition, each of which is set depending on a type of the recording medium for determining an amount of ink to be jetted for individual colors in response to an input signal.

12. The apparatus of claim 10, the storing section stores a plurality of limit amounts of ink to be jetted as the jet condition, each of which is set depending on a type of the recording medium for determining a total amount of ink to be jetted in response to a total input signal.

13. The apparatus of claim 10, the input device comprises a gloss sensor for detecting a gloss of the recording medium.
